(19) United States
(12) Patent Application Publication
(10) Pub. No.: US 2025/0350965 A1
(43) Pub. Date: Nov. 13, 2025

(54) METHOD AND APPARATUS FOR RADIO LINK FAILURE PREDICTION IN WIRELESS COMMUNICATION SYSTEM

(71) Applicant: Samsung Electronics Co., Ltd., Suwon-si (KR)

(72) Inventors: Taeseop LEE, Suwon-si (KR); Sangkyu BAEK, Suwon-si (KR)

(21) Appl. No.: 19/202,810

(22) Filed: May 8, 2025

(30) Foreign Application Priority Data
May 9, 2024 (KR) 10-2024-0061440

(51) Int. Cl. H04W 24/02; H04L 1/18

(52) U.S. Cl. CPC H04W 24/02; H04L 1/18

(57) ABSTRACT

The disclosure relates to a fifth generation (5G) or sixth generation (6G) communication system for supporting a higher data transmission rate. A method of a terminal connected to a first node and a second node in a dual connectivity environment is provided. The method includes performing a radio link failure (RLF) prediction of the second node, transmitting, to at least one of the first node or the second node, a failure prediction report based on the RLF prediction, and performing, by a packet data convergence protocol (PDCP) entity based on the RLF prediction, PDCP pre-recovery including at least one of stopping uplink PDCP packet data unit (PDU) splitting to a radio link control (RLC) entity related to the second node for a split bearer, or retransmitting unacknowledged uplink PDCP data PDU previously submitted to an acknowledged mode (AM) RLC entity related to the second node for which successful delivery has not been confirmed by the AM RLC entity.

### CROSS-REFERENCE TO RELATED APPLICATION(S)

This application is based on and claims priority under 35 U.S.C. § 119 (a) of a Korean patent application number 10-2024-0061440, filed on May 9, 2024, in the Korean Intellectual Property Office, the disclosure of which is incorporated by reference herein in its entirety.

### BACKGROUND

### 1. Field

The disclosure relates to terminal and base station in a wireless communication system. More particularly, the disclosure relates to methods and apparatus for a terminal to predict a radio link failure (RLF) in a dual connectivity (DC) scenario and perform operations to prevent data service interruption.

### 2. Description of Related Art

Fifth generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter-wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for enabling a UE to perform operations for predicting an RLF and preventing data service interruption in a wireless communication system.

Additional aspects will be set forth in part in the description which follows and, in part, will be apparent from the description, or may be learned by practice of the presented embodiments.

In accordance with an aspect of the disclosure, a method of a terminal connected to a first node and a second node in a dual connectivity environment is provided. The method includes performing a radio link failure (RLF) prediction of the second node, transmitting, to at least one of the first node or the second node, a failure prediction report based on the RLF prediction, and performing, by a packet data convergence protocol (PDCP) entity based on the RLF prediction, PDCP pre-recovery including at least one of stopping uplink PDCP packet data unit (PDU) splitting to a radio link control (RLC) entity related to the second node for a split bearer, or retransmitting unacknowledged uplink PDCP data PDU previously submitted to an acknowledged mode (AM) RLC entity related to the second node for which successful delivery has not been confirmed by the AM RLC entity.

In an embodiment, the method may further include suspending the PDCP pre-recovery based on at least one of an RLF detection, a PDCP pre-recovery operation period, a PDCP pre-recovery suspending indication, or a radio resource control (RRC) message from the at least one of the first node or the second node.

In an embodiment, the method may further include restoring, based on the suspending of the PDCP pre-recovery, configuration of at least one of cell group, data radio bearer (DRB), or RLC to a state configured prior to the PDCP pre-recovery.

In an embodiment, the method may further include transmitting, to the at least one of the first node or the second node, UE capability information related to at least one of the RLF prediction or the PDCP pre-recovery.

In an embodiment, the method may further include receiving, from the at least one of the first node or the second node, an RRC message including configuration of at least one of the RLF prediction or the PDCP pre-recovery.

In an embodiment, the failure prediction report includes at least one of a failure type, a predicted RLF occurrence time, or a measurement result related to the second node.

In an embodiment, the RLF prediction is performed in case that at least one of timers T310 or T312 is running, or in case that channel state of the at least one of the first node or the second node is poor.

In accordance with another aspect of the disclosure, a terminal connected to a first node and a second node in a dual connectivity environment is provided. The terminal includes at least one transceiver, at least one processor communicatively coupled to the at least one transceiver, and memory, communicatively coupled to the at least one processor, storing instructions executable by the at least one processor individually or in any combination to cause the terminal to perform an RLF prediction of the second node, transmit, to at least one of the first node or the second node, a failure prediction report based on the RLF prediction, and perform, by a PDCP entity based on the RLF prediction, PDCP pre-recovery including at least one of stopping uplink PDCP PDU splitting to an RLC entity related to the second node for a split bearer, or retransmitting unacknowledged uplink PDCP data PDU previously submitted to an AM RLC entity related to the second node for which successful delivery has not been confirmed by the AM RLC entity.

In an embodiment, the memory stores instructions executable by the at least one processor individually or in any combination to further cause the terminal to suspend the PDCP pre-recovery based on at least one of an RLF detection, a PDCP pre-recovery operation period, a PDCP pre-recovery suspending indication, or an RRC message from the at least one of the first node or the second node.

In an embodiment, the memory stores instructions executable by the at least one processor individually or in any combination to further cause the terminal to restore, based on the suspension of the PDCP pre-recovery, configuration of at least one of cell group, DRB, or RLC to a state configured prior to the PDCP pre-recovery.

In an embodiment, the memory stores instructions executable by the at least one processor individually or in any combination to further cause the terminal to transmit, to the at least one of the first node or the second node, UE capability information related to at least one of the RLF prediction or the PDCP pre-recovery.

In an embodiment, the memory stores instructions executable by the at least one processor individually or in any combination to further cause the terminal to receive, from the at least one of the first node or the second node, an RRC message including configuration of at least one of the RLF prediction or the PDCP pre-recovery.

In an embodiment, the failure prediction report includes at least one of a failure type, a predicted RLF occurrence time, or a measurement result related to the second node.

In an embodiment, the RLF prediction is performed in case that at least one of timers T310 or T312 is running, or in case that channel state of the at least one of the first node or the second node is poor.

The disclosure provides an apparatus and a method capable of effectively providing a data transmission service which is sensitive to latency in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a next-generation mobile communication system according to an embodiment of the disclosure;

FIG. 2 illustrates a radio protocol structure of long term evolution (LTE) and new radio (NR) systems according to an embodiment of the disclosure;

FIG. 3 illustrates a procedure of signaling between a UE and a base station in the case of the occurrence of a secondary cell group (SCG) failure, and a situation in which a data service is suspended, according to an embodiment of the disclosure;

FIG. 4 illustrates a procedure of signaling between a UE and a base station such that the UE predicts a radio link failure and recovers transmission data in a dual connectivity (DC) scenario according to an embodiment of the disclosure;

FIG. 5 illustrates a UE device according to an embodiment of the disclosure; and

FIG. 6 illustrates a base station device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms which will be described below are terms defined in consideration of the functions in the disclosure, and may be different according to users, intentions of the users, or customs. Therefore, the definitions of the terms should be made based on the contents throughout the specification. Hereinafter, embodiments of the disclosure will be described with reference to the accompanying drawings.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, higher signaling refers to a signal transfer scheme from a base station to a terminal via a downlink data channel of a physical layer, or from a terminal to a base station via an uplink data channel of a physical layer. The higher signaling may also be understood as radio resource control (RRC) signaling or a media access control (MAC) control element (CE).

In the following description of the disclosure, terms and names defined in the 3rd generation partnership project new radio (3GPP NR) or 3rd generation partnership project long term evolution (3GPP LTE) standards will be used for the sake of descriptive convenience. However, the disclosure is not limited by these terms and names, and may be applied in the same way to systems that conform other standards. In the disclosure, the term “gNB” may be interchangeably used with the term “eNB” for the sake of descriptive convenience. That is, a base station described as “eNB” may refer to “gNB”. Furthermore, the term “terminal” may refer to not only a mobile phone, an MTC device, an NB-IoT device, and a sensor, but also other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, the examples given above are not limiting.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB” for the sake of descriptive convenience. That is, a base station described as “eNB” may refer to “gNB”. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multiple-input multiple-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. The mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. However, mMTC, URLLC, and eMBB as described above are merely an example of different types of services, and service types to which the disclosure is applied are not limited to those mentioned above.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. Moreover, based on determinations by those skilled in the art, the embodiments of the disclosure may also be applied to other communication systems through some modifications without significantly departing from the scope of the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

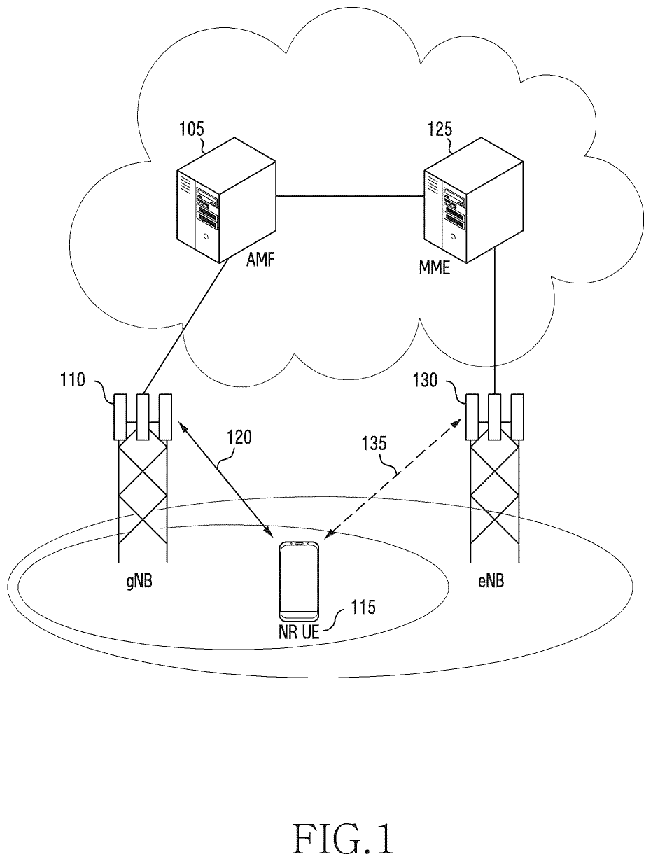

FIG. 1 illustrates a structure of a next-generation mobile communication system according to an embodiment of the disclosure.

Referring to FIG. 1, as illustrated therein, a radio access network of a next-generation mobile communication system (new radio (NR) or 5G) includes a next-generation base station (new radio node B, hereinafter gNB) 110, and a new radio core network (AMF) 105. A user equipment (new radio user equipment, hereinafter NR UE or NR terminal) 115 accesses an external network via the gNB 110 and the AMF 105.

In FIG. 1, the gNB 110 may correspond to an evolved node B (eNB) of a conventional LTE system. The gNB 110 may be connected via connection 120 to the NR UE 115 through a radio channel and provide outstanding services as compared to a conventional node B.

According to an embodiment of the disclosure, in the next-generation mobile communication system, since all user traffic is serviced through a shared channel, a device that collects state information, such as buffer statuses, available transmit power states, and channel states of UEs, and performs scheduling accordingly is required, and the gNB 110 serves as the device. In general, one gNB may control multiple cells.

According to an embodiment of the disclosure, in order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith.

Furthermore, according to an embodiment of the disclosure, the next-generation mobile communication system may employ an adaptive modulation & coding (hereinafter referred to as AMC) scheme for determining a modulation scheme and a channel coding rate according to a channel state of a UE. The AMF 105 may perform functions such as mobility support, bearer configuration, and quality of service (QOS) configuration. The AMF is a device responsible for various control functions as well as a mobility management function for a UE, and may be connected to multiple base stations. In addition, the next-generation mobile communication system may interwork with the existing LTE system, and the AMF 105 is connected to an MME 125 via a network interface. The MME 125 is connected to an eNB 130 that is an existing base station. A UE supporting LTE-NR dual connectivity may transmit/receive data while maintaining connections to both the gNB 110 via connection 120 and the eNB 130 via connection 135.

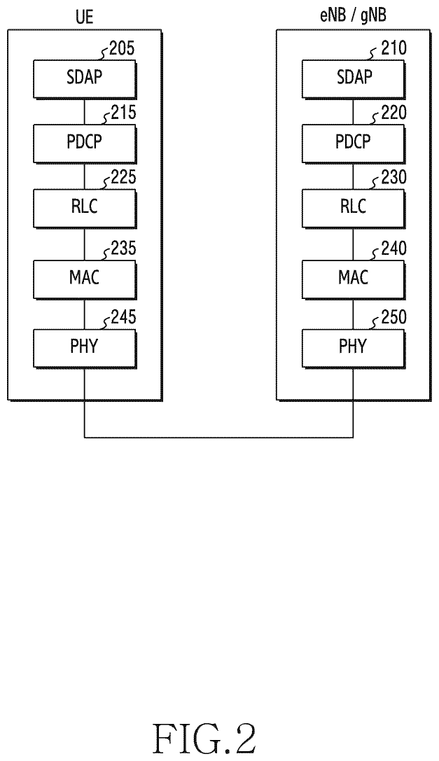

FIG. 2 illustrates a radio protocol structure in LTE and NR systems according to an embodiment of the disclosure.

Referring to FIG. 2, a radio protocol of an NR system may include a service data adaptation protocol (SDAP) 205 or 210, a packet data convergence protocol (PDCP) 215 or 220, a radio link control (RLC) 225 or 230, and a medium access controls (MAC) 235 or 240 on each of UE and gNB sides. The SDAP 205 or 210 may perform an operation for mapping each QoS flow to a specific data radio bearer (DRB), and the SDAP configuration corresponding to each DRB may be given from the upper layer (for example, RRC layer).

According to an embodiment, the PDCP 215 or 220 may be responsible for IP header compression and/or restoration, and additionally may perform a re-ordering operation in order to provide a data in-order delivery service to a higher layer. In addition, the RLC 225 or 230 may reconstruct a PDCP PDU into appropriate sizes. The MAC 235 or 240 may be connected to several RLC layer devices configured for a single UE, and perform operations of multiplexing RLC PDUs into an MAC PDU and demultiplexing an MAC PDU into RLC PDUs. A physical (PHY) layer 245 or 250 may perform operations of channel-coding and modulating upper layer data, producing an orthogonal frequency-division multiplexing (OFDM) symbol therefrom and transmitting the same through a radio channel, or demodulating an OFDM symbol received through the radio channel, channel-decoding the same, and delivering the same to the higher layer.

In addition, according to an embodiment of the disclosure, the PHY layer 245 or 250 may use a hybrid automatic repeat request (HARQ) for additional error correction, and the receiving end may transmit one bit to the transmitting end to indicate whether a packet transmitted thereby has been received. Information regarding whether the receiving end has received a packet from the transmitting end may be referred to as HARQ acknowledgment (ACK)/negative acknowledgement (NACK) information. In the case of an LTE system, downlink HARQ ACK/NACK information regarding uplink data transmission may be transmitted through a physical HARQ indicator channel (PHICH). In the case of an NR system, downlink HARQ ACK/NACK information regarding uplink data transmission may be transmitted through a physical downlink control channel (PDCCH), which is used to transmit a downlink and/or uplink resource allocation or the like, and the base station may determine, based on the UE's scheduling information, whether retransmission is necessary or new transmission is to be performed.

The reason the base station in an NR system determines, based on the UE's scheduling information, whether retransmission is necessary or new transmission is to be performed, unlike LTE, is because an asynchronous HARQ is applied in the NR. Uplink HARQ ACK/NACK information regarding downlink data transmission may be transmitted through a physical uplink control channel (PUCCH) or through a physical uplink shared channel (PUSCH). The PUCCH may be generally transmitted in the uplink of the primary cell (PCell) to be described below. However, in case that the UE supports the same, HARQ ACK/NACK information regarding the secondary cell (SCell) (described later) may be transmitted, and the SCell may be referred to as a PUCCH SCell.

Although not illustrated in the drawing, a radio resource control (RRC) layer may exist on each upper layer of the PDCP layer of the UE and the base station, and the RRC layer may exchange access/measurement-related configuration control messages for radio resource control.

The PHY layer 245 or 250 may include one or multiple frequencies/carriers, and a technology for simultaneously configuring and using multiple frequencies may be referred to as carrier aggregation (hereinafter CA). The CA technology refers to a technology for, instead of using only one carrier for communication between a UE and a base station (for example, eNB or gNB), additionally using a main carrier and one or multiple subcarriers to increase the amount of transmission as much as the number of subcarriers. Meanwhile, a cell in a base station, which uses the main carrier in LTE and NR systems, may be referred to as a primary cell or PCell, and a cell in a base station, which uses the subcarriers, may be referred to as a secondary cell or SCell.

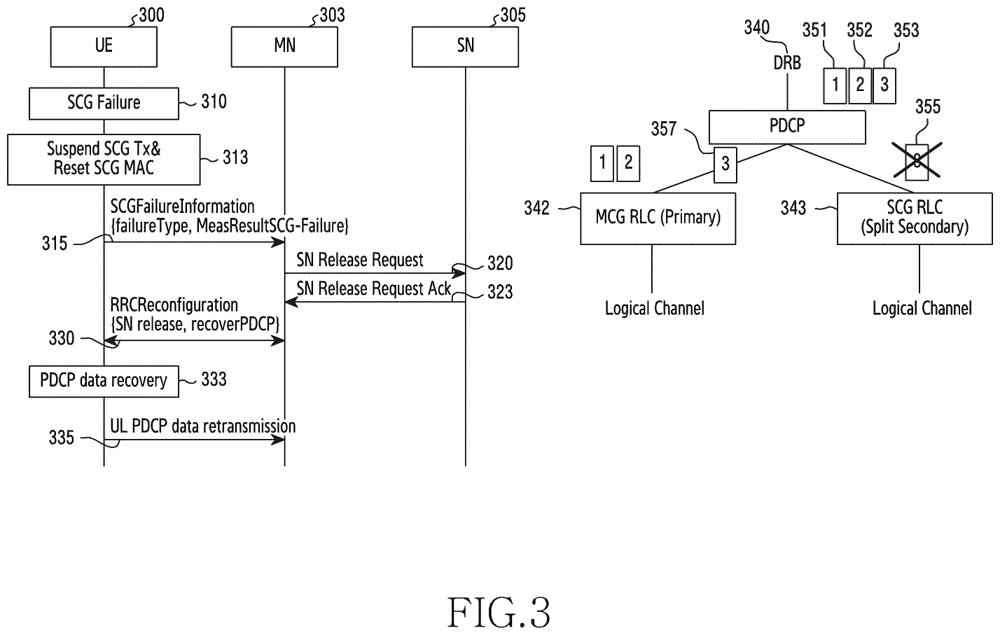

FIG. 3 illustrates a procedure of signaling between a UE and a base station in the case of the occurrence of a secondary cell group (SCG) failure, and a situation in which a data service is suspended, according to an embodiment of the disclosure.

Referring to FIG. 3, the UE 300 may operate in a dual connectivity (DC) scenario in which the UE 300 remains connected to the master node (MN) 303 and the secondary node (SN) 305 simultaneously. In the DC scenario, split data radio bearers (DRBs) 340 may be configured for the UE 300. The split DRBs may be connected/mapped to the MCG RLC 342 which transmits data through master cell group (MCG) radio resources and the SCG RLC 355 which transmits data through secondary cell group (SCG) radio resources, respectively. The split DRBs may have PDCP layers (entities) configured to split pieces of user data (PDCU SDUs) 351, 352, and 353 transmitted by the UE 300 through the uplink to MCG RLCs or SCG RLCs. One of the two RLC bearers may be configured as the primary RLC (or path), and the other may be configured as the split secondary RLC (or path). In case that the size of data which stands by in the buffer for uplink transmission on the PDCP layer exceeds a specific threshold (ul-DataSplitThreshold), the UE 300 may split PDCP PDUs due for uplink transmission to the primary RLC and the split secondary RLC sides, respectively. On the other hand, in case that the size of data which stands by in the buffer for uplink transmission on the PDCP layer is smaller than the specific threshold (ul-DataSplitThreshold), the UE 300 may transmit PDCP PDUs due for uplink transmission through the primary RLC only. This embodiment assumes that, among PDCP PDUs due for uplink transmission through the split DRBs 340, packets nos. 1 and 2 351 and 352 are split to the primary RLC (MCG RLC) 342, and packet no. 3 353 is split to the secondary RLC (SCG RLC) 343.

In step 310, the UE 300 may detect an SCG failure (or SCG RLF). More specifically, the UE 300 may detect the occurrence of an SCG failure in case that T310/T312 expires in the primary secondary Cell (PSCell), a random access problem occurs in the SCG MAC, the maximum number of retransmissions is reached in the SCG RLC, or other events occur.

In step 313, the UE 300 may suspend the SCG transmission with regard to all SRBs/DRBs and reset the SCG MAC as a follow-up measure after detecting the SCG failure in step 310. Transmission of packet no. 3 split to the secondary RLC (SCG RLC) 343 may be suspended (355) as a result of suspending the SCG transmission with regard to all SRBs/DRBs and resetting the SCG MAC by the UE 300.

In step 315, the UE 300 may transmit an SCGFailureInformation message to the MN 303 to report the occurrence of the SCG failure to the network. The SCGFailureInformation message may include the reason the SCG failure has occurred (failureType), and a measurement result value (MeasResultSCG-Failure) regarding measurement objectives (Mos) configured with regard to the SCG. Upon receiving the SCGFailureInformation message, the MN 303 may determine that the UE 300 that has transmitted the SCGFailureInformation message needs to change the SN 305 or release the connection to the SN 305, based on the failureType and MeasResultSCG-Failure included in the message. This embodiment assumes that, upon receiving the SCGFailureInformation message, the MN 303 determines that the UE 300 needs to release the SN 305.

In step 320, the MN 303 may transmit an SN release request message to the SN 305, thereby requesting the SN 305 to perform SN release with regard to the UE 300 that has transmitted the SCGFailureInformation message to the MN 303.

In step 323, the SN 305 may transmit an SN release request ACK message to the MN 303 in response to the SN release message received from the MN 303 in step 320. Upon receiving the SN release request ACK message, the MN 303 may finally release SN release with regard to the UE 300.

In step 330, the MN 303 may instruct the UE 300 to perform SN release through a RRCReconfiguration procedure. A PDCP recovery operation regarding the split DRB 340 may be configured together. In other words, a recoverPDCP indicator may be configured in the DRB-ToAddMod IE corresponding to the DRB.

In step 333, the UE 300 may perform a PDCP recovery operation regarding the DRB in case that a PDCP recovery operation regarding the split DRB has been configured in step 330. The PDCP recovery operation may refer to an operation of retransmitting all PDCU data PDUs which have been allocated/submitted to a re-established or released acknowledged mode (AM) RLC, and successful transmission of which has not been confirmed by the lower layer. Specifically, the PDCP recovery operation may may be described by specifications as in Table 1 below:

TABLE 1
perform retransmission of all the PDCP Data PDUs previously submitted
to re-established or released AM RLC entities in ascending order of
the associated COUNT values for which the successful delivery has not
been confirmed by lower layers, following the data submission procedure
in clause 5.2.1.

In this embodiment, the UE 300 may retransmit packet no. 3 which has previously been split to the split secondary RLC (SCG RLC) 343. More specifically, the packet no. 3 may be retransmitted (357) through the MCG RLC because the UE 300 has been configured to release the SN in step 330, and the RLC entity corresponding to the split secondary RLC (SCG RLC) has thus been released together.

In step 335, the UE 300 may retransmit (357) packet no. 3 which has previously been split to the split secondary RLC (SCG RLC) 343.

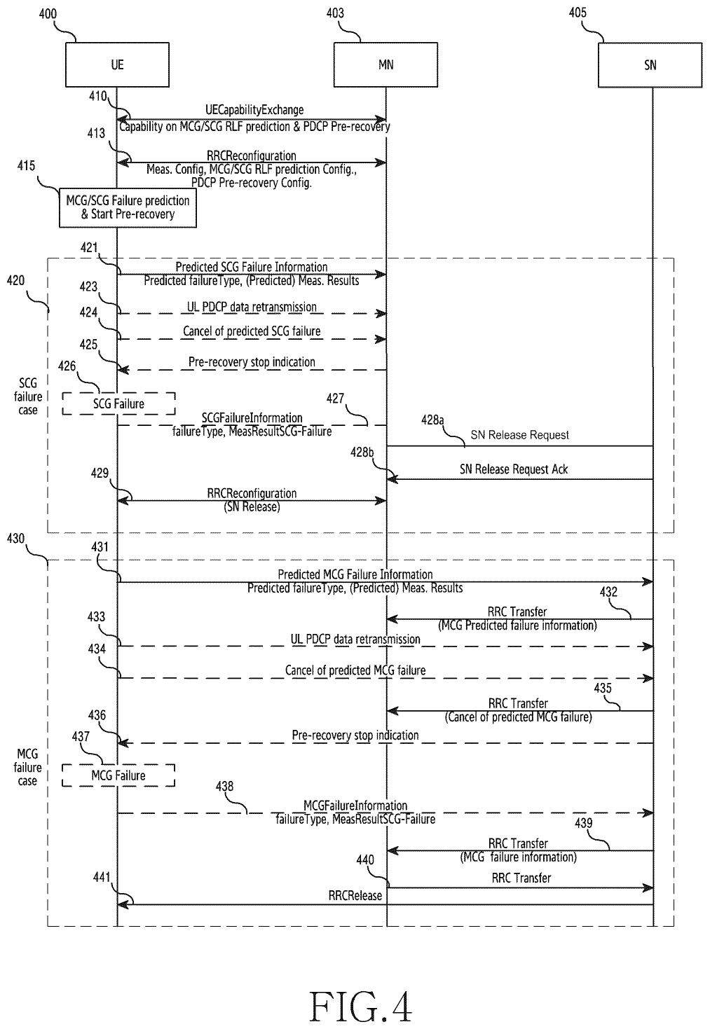

In this embodiment, even in case that an SCG failure has occurred in the UE 300 in the DC scenario, PDCP data PDU no. 3 353 which has been allocated/submitted to the SCG RLC may be finally retransmitted through the MCG RLC. However, data transmission interruption (UL data interruption) may actually occur, in step 310, from the timepoint of the occurrence of the SCG failure to the timepoint of retransmission of the uplink PDCP data PDU, and the data transmission interruption may last for a specific period of time or longer, thereby adversely affecting the data transmission quality. Such data transmission interruption may also occur in case that an MCG failure is detected in the DC scenario, identically to data transmission interruption in case that an SCG failure is detected as described above. In order to reduce the time for which data transmission interruption continues, the UE 300 may perform a PDCP pre-recovery operation in order to predict the MCG failure or SCG failure and to minimize the data transmission interruption time. The PDCP pre-recovery operation which may be performed by the UE in order to predict the MCG failure or SCG failure and to minimize the data transmission interruption time will be described in detail with reference to FIG. 4.

FIG. 4 illustrates a procedure of signaling between a UE and a base station such that the UE predicts a radio link failure and recovers transmission data in a dual connectivity (DC) scenario, according to an embodiment of the disclosure.

Referring to FIG. 4, the UE 400 may operate in a dual connectivity (DC) scenario in which the UE 400 remains connected to the master node (MN) 403 and the secondary node (SN) 405 simultaneously. In order to minimize the data transmission interruption time in case that an MCG failure or SCG failure occurs, the UE 400 may predict the MCG failure or SCG failure and perform a PDCP pre-recovery operation. A procedure of signaling between the UE 400 and the base station (MN 403 or SN 405) for predict the MCG failure or SCG failure and perform the PDCP pre-recovery operation will be described below in detail.

In step 410, the UE may report UE capability information related to MCG/SCG failure prediction and PDCP pre-recovery operations to the base station (MN) 403. More specifically, the MN 403 may request the UE 400 to provide UE capability information through a UECpabilityEnquiry message. The UECpabilityEnquiry message may include separate indicators for requesting the UE 400 to provide UE capability information related to the MCG/SCG failure prediction operation and the PDCP pre-recovery operation, respectively. For example, a first indicator for requesting capability information related to the MCG/SCG failure prediction operation and a second indicator for requesting UE capability information related to the PDCP pre-recovery operation may be separately configured and then included in the UECpabilityEnquiry message. As another example, a first indicator for requesting capability information related to the MCG failure prediction operation, a second indicator for requesting capability information related to the SCG failure prediction operation, and a third indicator for requesting UE capability information related to the PDCP pre-recovery operation may be separately configured and then included in the UECpabilityEnquiry message. As another example, a single identifier for commonly requesting capability information related to the MCG/SCG failure prediction operation and UE capability information related to the PDCP pre-recovery operation may be configured and included in the UECpabilityEnquiry message. The UE 400 may report UE capability information to the base station (MN) 403 through a UECapabilityInformation message. In this case, the UE may report, to the base station (MN) 403, whether the MCG/SCG failure prediction and PDCP pre-recovery operations are supported or not. To this end, an indicator for indicating whether MCG failure prediction, SCG failure prediction, and PDCP pre-recovery operations are supported or not may be configured/defined and included in the UECapabilityInformation message. Additionally, in order to report UE capability information regarding the MCG failure prediction, SCG failure prediction, and PDCP pre-recovery operations, individual indicators may be defined/configured and used with regard to respective operations. In addition, a common indicator may be configured/defined and used to report UE capability information with regard to a combination of at least one of the three operations. For example, in case that a common one-bit indicator is configured/defined regarding MCG failure prediction and SCG failure prediction, and in case that the indicator has the value of 0 (or 1), the indicator may indicate that MCG failure prediction and SCG failure prediction are not supported, and in case that the indicator has the value of 1 (or 0), the indicator may indicate that MCG failure prediction and SCG failure prediction are supported.

In addition, a three-bit indicator may be defined such that every number of cases regarding whether MCG failure prediction, SCG failure prediction, and PDCP pre-recovery operations are supported or not can be covered, and the three-bit indicator may be configured, for example, as in the following table:

TABLE 2

| | MCG failure | SCG failure | PDCP |
|---|---|---|---|
| Bit value | prediction | prediction | pre-recovery |
| 000 | Not supported | Not supported | Not supported |
| 001 | Not supported | Not supported | Supported |
| 010 | Not supported | Supported | Not supported |
| 011 | Not supported | Supported | Supported |
| 100 | Supported | Not supported | Not supported |
| 101 | Supported | Not supported | Supported |
| 110 | Supported | Supported | Not supported |
| 111 | Supported | Supported | Supported |

In step 413, the base station (MN) 403 may provide the UE 400 with MCG and SCG configuration information through an RRCReconfiguration procedure. Therefore, the UE 400 may operate in a dual connectivity (DC) scenario in which data is transmitted/received if the connection to the base station (MN) 403 and the SN 405 is maintained later. In addition, the MN 403 may configure a split DRB such that the UE 400 can simultaneously transmit data through the MCG and SCG as in the embodiment in FIG. 3. In addition, the base station (MN) 403 may configure the UE 400 so as to perform radio resource management (RRM) measurement operations necessary to maintain connectivity and support mobility with regard to the MCG/SCG.

Additionally, the base station (MN) 403 may configure the UE 400 so as to predict and report the MCG failure and SCG failure. In order to configure the MCG and SCG failure prediction/reporting operations, separate indicators (for example, MCGfailurePredictReport-rXX and SCGfailruePredictReport-rXX) may be included/configured in MCG and SCG failure prediction/reporting operation configurations with regard to respective functions, or a common indicator (for example, MCG-SCGfailurePredictReport-rXX) applied to both functions may be included/configured in MCG and SCG failure prediction/reporting operation configurations. The time window starting from the current timepoint, during which the UE 400 has to predict MCG/SCG failures (in other words, the prediction time window (T) for MCG/SCG failure prediction) may be configured together in the MCG and SCG failure prediction/reporting operation configurations.

Additionally, the base station (MN) 403 may configure the UE 400 so as to perform a PDCP pre-recovery operation for minimizing the data transmission interruption time in case that the UE 400 has predicted an MCG/SCG failure. A separate indicator (for example, preRecoverPDCP-rXX) may be included/configured in the PDCP pre-recovery operation configuration in order to configure the PDCP pre-recovery operation. The indicator may be included/configured in the PDCP pre-recovery operation with regard to each MAC-Cellgroup, DRB, or UE.

The MCG/SCG failure prediction/reporting operation will be described in steps 423 and 431 in FIG. 4, and the PDCP pre-recovery operation will be described in step 415 in FIG. 4.

In step 415, the UE 400 may perform the MCG/SCG failure prediction operation according to the base station (MN) 403 configuration in step 413. The MCG/SCG failure prediction may be performed through an AI/ML model inference or a rule-based algorithm. Additionally, if the UE 400 keeps performing the MCG/SCG failure prediction operation, the UE 400 unnecessarily consumes a large amount of energy, and this may cause a problem in that the UE 400 will be heated. In order to solve such a problem, the UE 400 may perform the MCG/SCG failure prediction operation only in case that there is a high possibility that the MCG/SCG failure will actually occur. As an example of performing the MCG/SCG failure prediction operation in case that there is a high possibility that the MCG/SCG failure will occur, the UE 400 may perform the MCG/SCG failure prediction operation only in case that timer T310/T312 has been started and is currently driven. The T310/T312 timer may be defined as in the following table:

TABLE 3

| | | | |
|---|---|---|---|
| T310 | The timer T310 starts | It stops upon receiving | At expiry, IF |
| | upon detecting physical | N311 consecutive In-sync. | security is not |
| | layer problems for PCell | indications from lower | activated “it does |
| | i.e. upon receiving N310 | layers for PCell, upon | to RRC_IDLE state” |
| | consecutive out-of-sync | triggering the handover | ELSE “it initiates |
| | indications from lower | procedure and upon | connection |
| | layers. | initiating the connection | establishment |
| | | re-establishment procedure. | procedure” |
| T312 | The timer T312 starts | It stops upon receiving | At expiry, IF |
| | upon triggering a | N311 consecutive in-sync | security is not |
| | measurement report for | indications from lower | activated “the |
| | measurement identity | layers | timer goes to |
| | for which T312 has been | upon triggering the | RRC_IDLE state” |
| | configured while T310 | handover procedure | ELSE “it initiates |
| | timer is running. | upon Initiating connection | the connection |
| | | re-establishment procedure | re-establishment |
| | | and | procedure” |
| | | upon the expiry of T310 | |
| | | timer. | |

As another example of performing the MCG/SCG failure prediction operation in case that there is a high possibility that the MCG/SCG failure will occur, the UE 400 may perform the MCG/SCG failure prediction operation only in case that the channel state with the PCell/PSCell is poor (in other words, only in case that the reference signal received power (RSRP) measured with regard to the PCell/PSCell is lower than a specific threshold value). The RSRP threshold value may be configured by the base station in step 413.

In case that the MCG/SCG failure has been predicted, the UE 400 may perform a combination of at least one of the following operations according to the base station configuration in step 413. The UE 400 may determine that the MCG/SCG failure is predicted in case that the MCG/SCG failure occurrence probability predicted based on AI/ML is higher than a specific threshold value. In order to enable the UE 400 to determine whether the MCG/SCG failure is predicted or not, the base station may configure a specific probability threshold value for the UE in step 413. In addition, no separate threshold value may be configured by the base station in order to enable the UE 400 to determine whether the MCG/SCG failure is predicted or not, and the UE 400 may autonomously determine whether the MCG/SCG failure is predicted or not, by using 50% as the threshold value.
Operation 1 (predicted MCG/SCG failure report): in case that the MCG/SCG failure has been predicted, the UE 400 may report the same to the network (MN 403 or SN 405) as in step 421 or 431 described below. In order to report, to the network (MN 403 or SN 405), that the MCG/SCG failure has been predicted, the UE 400 may transmit an RRC message (for example, PredictedMCGFailureInformation and PredictedSCGFailureInformation) including predicted MCG/SCG failure information to the MN 403 or SN 405. The MCG/SCG failure information may include a combination of at least one of the predicted MCG/SCG failure occurrence timepoint (that is, the timepoint at which the MCG/SCG failure is predicted to occur), the predicted failure Type (for example, T310/T312 expiration, the occurrence of a random access problem at the SCG MAC, the maximum number of retransmissions reached at the SCG RLC, and the like), and the (predicted) measurement result associated with the MCG/SCG.
Operation 2 (PDCP pre-recovery): in case that the MCG/SCG failure has been predicted, the UE 400 may perform a PDCP pre-recovery operation. The UE 400 may determine that the MCG/SCG failure has been predicted in case that the MCG/SCG failure occurrence probability predicted based on AI/ML is higher than a specific threshold value. To this end, the base station may configure a specific probability threshold value for the UE in step 413. Alternatively, the UE 400 may autonomously determine whether the MCG/SCG failure is predicted or not, by using 50% as the threshold value, without a separate threshold value configured by the base station. The PDCP pre-recovery operation for minimizing the data transmission interruption time may include the following operations 2-1 and 2-2. The following operations 2-1 and 2-2 may be separately configured by individual indicators in step 413, respectively, or may be configured together by a common indicator.
Operation 2-1 (stop splitting UL PDCP PDU to MCG/SCG RLC for split bearer): in case that the MCG failure or SCG failure is predicted, the UE 400 may no longer perform data transmission/submission/split to the RLC entity which transmits data by using a cell group (CG) resource, regarding which a failure (radio link failure (RLF)) is predicted, with regard to split DRBs. To this end, at least one of the following options may be used with regard to split DRBs.
Option 1
(In case that the SCG failure has been predicted) the UE 400 may release the SCG RLC and may change the primary RLC to the MCG RLC.
(In case that the MCG failure has been predicted) the UE 400 may release the MCG RLC and may change the primary RLC to the SCG RLC.
Option 2
(In case that the SCG failure has been predicted) the UE 400 may consider that the SCG RLC is temporarily released or suspended.
(In case that the MCG failure has been predicted) the UE 400 may consider that the MCG RLC is temporarily released or suspended.
Option 3
(In case that the SCG failure has been predicted) the UE 400 may change the primary RLC to the MCG RLC.
(In case that the MCG failure has been predicted) the UE 400 may change the primary RLC to the SCG RLC.
Option 4
(In case that the SCG failure has been predicted) the UE 400 may change the primary RLC to the MCG RLC and may configure ul-DataSplitThreshold to be “infinity.” By configuring the ul-DataSplitThreshold regarding the primary RLC (MCG RLC) to be “infinity,” data split to the SCG RLC may not occur.
(In case that the MCG failure has been predicted) the UE 400 may change the primary RLC to the SCG RLC and may configure ul-DataSplitThreshold to be “infinity.” By configuring the ul-DataSplitThreshold regarding the primary RLC (SCG RLC) to be “infinity,” data split to the MCG RLC may not occur.
Option 5
(In case that the MCG/SCG failure has been predicted) the UE 400 may activate the PDCP pre-recovery operation with regard to the split DRB. In other words, the UE may no longer perform the split operation with regard to the corresponding DRB, and may perform a PDCP duplication operation in which the UL PDCP PDU is duplicated and is redundantly transmitted to both the MCG RLC and SCG RLC connected to the corresponding DRB. Above-described option 5 is different from above-described options 1/2/3/4 in that the UE 400 continuously transmits/submits/splits uplink data even to the RLC regarding which a failure is predicted. According to above-described option 5, the UE 400 duplicates and transmits the UL PDCP PDU to the RLC regarding which no failure is predicted, thereby preventing data transmission interruption.
Operation 2-2 (fast UL data PDCP retransmission for split DRB): in case that the MCG failure or SCG failure is predicted, the UE 400 may perform a UL data PDCP retransmission operation with regard to split DRBs. The retransmission operation may refer to an operation of retransmitting all PDCP data PDUs which have been allocated/submitted to an AM RLC that uses a failure-predicted cell group (CG) resource, and successful transmission of which from the lower layer has not been confirmed. Specifically, the PDCP pre-recovery operation 2-2 may be described by specifications as in the following Table 4:

```
TABLE 4
1> If SCG failure is predicted:
  2> for a split DRB, perform retransmission of all the PDCP Data
PDUs previously submitted to AM SCG RLC entities in ascending order
of the associated COUNT values for which the successful delivery
has not been confirmed by lower layers
1> If MCG failure is predicted:
  2> for a split DRB, perform retransmission of all the PDGP Data
PDUs previously submitted to AM MCG RLC entities in ascending order
of the associated COUNT values for which the successful delivery
has not been confirmed by lower layers.
```

Alternatively, the operation 2-2 may be replaced with the PDCP recovery operation described above in step 333 in FIG. 3.

Operation 2 (PDCP pre-recovery) may be started at the timepoint at which the UE has predicted the MCG/SCG failure. In addition, the UE 400 may suspend the PDCP pre-recovery operation in case that at least one of the conditions described below is satisfied.
Condition 1: the MCG/SCG failure prediction result is changed, and no MCG/SCG failure is thus predicted any more.
Condition 2: an actual MCG/SCG failure is detected.
Condition 3: an actual MCG/SCG failure is detected, and MCG/SCG failure information is transmitted to the base station (MN or SN).
Condition 4: the predicted MCG/SCG failure occurrence timepoint (that is, the timepoint at which the MCG/SCG failure is predicted to occur) (described above in operation 1) has lapsed.
Condition 5: the pre-recovery operation period (that is, the duration for which the UE may perform a pre-recovery operation) configured by the network has lapsed. In this case, the network needs to configure the pre-recovery operation period for the UE in step 413.
Condition 6: the UE is explicitly instructed to suspend pre-recovery by the base station (as described below in steps 425 and 436).
Condition 7: the UE has received an RRCReconfiguration or RRCRelease message from the base station (as described below in steps 429 and 441).

In case that the PDCP pre-recovery operation is suspended under the above conditions, the UE 400 may restore existing Cellgroup/DRB/RLC configurations (in other words, restore all configurations as before the PDCP pre-recovery operation 2-1 is performed), and may suspend the fast UL PDCP data retransmission operation (in other words, the above-described PDCP pre-recovery operation 2-2).

Hereinafter, a procedure of signaling between the UE and the base station (MN) and a procedure of signaling between the MN and the SN, in a situation in which the UE 400 has predicted an SCG failure, will be described as 420 with reference to steps 421 to 429 in FIG. 4.

In step 421, the UE 400 may transmit an RRC message including SCG failure information predicted according to operation 1 (predicted MCG/SCG failure report) described above in step 415 to the MN 403. The SCGFailureInformation message may be reused as the RRC message including predicted SCG failure information, or a newly defined message (for example, PredictedSCGFailureInformation) may be used as the RRC message including predicted SCG failure information. Upon receiving the RRC message, the base station (MN) 403 may skip the process of receiving the SCG failure report from the UE 400, as described below in step 427, and may determine SN release. In this case, the MN 403 may immediately agree with the SN 405 about SN release through step 428a/b (described below), and may configure the UE 400 to release the SN 405 through an RRCReconfiguration procedure in step 429.

In step 423, the UE 400 may retransmit the UL data PDCP PDU through the MCG RLCL with regard to the split DRB according to operation 2-2 described above in step 415.

In step 424, the UE may transmit an RRC message for updating or canceling the predicted SCG failure information reported to the base station (MN) 403 in step 421. For example, after the UE has predicted the SCG failure in step 415 and then transmitted the predicted SCG failure information to the MN 403 in step 421, the UE's prediction result may change, and the information reported in step 421 may thus need to be canceled or modified. More specifically, in case that the predicted SCG failure information has changed such that the SCG failure information reported in step 421 needs to be updated (modified), the UE 400 may transmit an RRC message including re-predicted SCG failure information to the MN 403 as in step 421. In addition, in case that the information reported in step 421 needs to be canceled because no SCG failure is predicted any more, the UE 400 may transmit an RRC message including an indicator (for example, cancelSCGfailurePrediction-rXX) indicating cancelation of the previously reported SCG failure prediction to the MN 403. Upon receiving the RRC message including an indicator (for example, cancelSCGfailurePrediction-rXX) indicating cancelation of the previously reported SCG failure prediction, the base station (MN) 403 may instruct the UE 400 to suspend the PDCP pre-recovery operation (in other words, operation 2 described above in step 415) in case that no SCG failure is predicted any more.

In step 425, the base station (MN) 403 may instruct the UE 400 to suspend the PDCP pre-recovery operation (in other words, operation 2 described above in step 415) through RRC/MAC/PHY signaling.

In step 426, the UE may detect an actual SCG failure, not a predicted SCG failure. More specifically, the UE 400 may detect the occurrence of an actual SCG failure, not an SCG failure predicted in case that T310/T312 expires in the PSCell, a random access problem occurs in the SCG MAC, the maximum number of retransmissions is reached in the SCG RLC, or other events occur.

In step 427, the UE 400 may transmit an SCGFailureInformation message to the MN 303 to report, to the network, that an actual SCG failure, not a predicted SCG failure, has occurred. The SCGFailureInformation message may include the reason the SCG failure has occurred (failureType), and a measurement result value (MeasResultSCG-Failure) regarding measurement objectives (Mos) configured with regard to the SCG. Upon receiving the SCGFailureInformation message, the MN 303 may determine that the UE 300 needs to change the SN 305 or release the connection to the SN 305, based on the failure Type and MeasResultSCG-Failure included in the SCGFailureInformation message. Hereinafter, this embodiment assumes that the MN 303 determines that the UE needs to release the SN 305.

In step 428a, the MN 403 may transmit an SN release request message to the SN 405, thereby requesting SN release regarding the UE 400.

In step 428b, the SN 405 may transmit an SN release request ACK message to the MN 403 in response to the SN release request message received from the MN 403 in step 428a. Upon receiving the SN release request ACK message, the MN 403 may finally determine SN release regarding the UE 400.

In step 429, the MN 403 may instruct the UE 400 to perform SN release through an RRCReconfiguration procedure.

Hereinafter, a procedure of signaling between the UE and the base station (MN) and a procedure of signaling between the MN and the SN, in a situation in which the UE 400 has predicted an MCG failure, will be described as 430 with reference to steps 431 to 441 in FIG. 4.

In step 431, the UE 400 may transmit an RRC message including MCG failure information predicted according to operation 1 (predicted MCG/SCG failure report) described above in step 415 to the SN 405. The MCGFailureInformation message may be reused as the RRC message including predicted SCG failure information, or a newly defined RRC message (for example, PredictedMCGFailureInformation) may be used as the RRC message including predicted MCG failure information.

In step 432, the SN 405 may transfer/forward the RRC message (for example, PredictedMCGFailureInformation) received from the UE 400 in step 431 to the MN 403 without modification. Upon receiving the RRC message, the MN 403 may skip the process of receiving the MCG failure report from the UE 400 through steps 438 and 439 (described below), and may determine RRC release. In this case, the MN 403 may configure the UE so as to release the RRC connection immediately through steps 410 and 441 (described below).

In step 433, the UE 400 may retransmit the UL data PDCP PDU through the SCG RLCL with regard to the split DRB according to operation 2-2 described above in step 415.

In step 434, the UE may transmit an RRC message for updating or canceling the predicted MCG failure information reported to the base station (SN) 405 in step 431 to the SN 405. For example, after the UE has predicted the MCG failure in step 415 and then transmitted the predicted MCG failure information to the SN 405 in step 431, the UE's prediction result may change, and the information reported in step 431 may thus need to be canceled or modified. More specifically, in case that the predicted MCG failure information has changed such that the information reported in step 431 needs to be updated (modified), the UE 400 may transmit an RRC message including re-predicted MCG failure information to the SN 405 as in step 431. In addition, in case that the information reported in step 431 needs to be canceled because no MCG failure is predicted any more, the UE 400 may transmit an RRC message including an indicator (for example, cancelMCGfailurePrediction-rXX) indicating cancelation of the previously reported MCG failure prediction to the SN 405. Upon receiving the RRC message including an indicator indicating cancelation of the previously reported MCG failure prediction, the base station (SN) 405 may instruct the UE 400 to suspend the PDCP pre-recovery operation (in other words, operation 2 described above in step 415) in case that no MCG failure is predicted any more.

In step 435, the SN 405 may transfer the RRC message received from the UE in step 434 to the MN 403 without modification.

In step 436, the base station (SN) 405 may instruct the UE 400 to suspend the PDCP pre-recovery operation (in other words, operation 2 described above in step 415) through RRC/MAC/PHY signaling.

In step 437, the UE may detect an actual MCG failure, not a predicted MCG failure. More specifically, the UE 400 may detect the occurrence of an actual MCG failure, not an MCG failure predicted in case that T310/T312 expires in the PCell, a random access problem occurs in the MCG MAC, the maximum number of retransmissions is reached in the MCG RLC, or other events occur.

In step 438, the UE 400 may transmit an MCGFailureInformation message to the SN 405 to report, to the network, that an actual MCG failure, not a predicted MCG failure, has occurred. The MCGFailureInformation message may include the reason the MCG failure has occurred (failureType), and measurement result values (MeasResultList2NR and MeasResultSCG-Failure) regarding measurement objectives (Mos) configured with regard to the MCG and SCG.

In step 439, the SN 405 may transfer the RRC message (MCGFailureInformation) received from the UE 400 in step 438 to the MN 403 without modification. Upon receiving the MCGFailureInformation message, the MN 403 may determine that the UE 400 needs to change the PCell or perform RRC release, based on the failureType and measurement result information included in the message. Hereinafter, this embodiment assumes that the MN 403 determines that the UE 400 needs to perform RRC release.

In step 440, the MN 403 may transfer an RRCRelease message which is to be transmitted to the UE 400 to the SN 405.

In step 441, the SN 405 may transfer the RRCRelease message received from the MN 403 to the UE 400. Upon receiving the RRCRelease message, the UE 400 may transition to the RRC_IDLE or RRC_INACTIVE state.

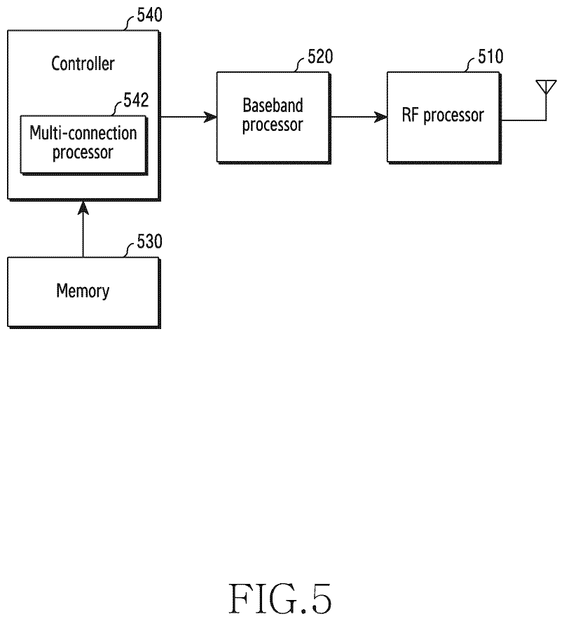

FIG. 5 is a block diagram illustrating an internal structure of a UE according to an embodiment of the disclosure.

Referring to FIG. 5, the UE may include a radio frequency (RF) processor 510, a baseband processor 520, memory 530, and a controller 540. Of course, the example given above is not limiting, and the UE may include a smaller or larger number of components than the components illustrated in FIG. 5. The RF processor 510 may perform a function for transmitting and receiving a signal via a wireless channel, such as band conversion and amplification of the signal. That is, the RF processor 510 may up-convert a baseband signal provided from the baseband processor 520 to an RF band signal, may transmit the same through an antenna, and may down-convert an RF band signal received through the antenna to a baseband signal. For example, the RF processor 510 may include a transmission filter, a reception filter, an amplifier, a mixer, an oscillator, a digital-to-analog converter (DAC), an analog-to-digital converter (ADC), and the like. Although only one antenna is illustrated in FIG. 5, the UE may include multiple antennas. In addition, the RF processor 510 may include multiple RF chains. Furthermore, the RF processor 510 may perform beamforming. For the beamforming, the RF processor 510 may adjust the phase and magnitude of each of signals transmitted and received through multiple antennas or antenna elements. In addition, the RF processor 510 may perform multiple-input multiple-output (MIMO), and may receive multiple layers when performing a MIMO operation. The RF processor 510 may appropriately configure multiple antennas or antenna elements under the control of the controller 540 so as to perform received beam sweeping, or may adjust the direction and beam width of received beams such that received beams are coordinated with transmitted beams.

The baseband processor 520 may perform functions of conversion between baseband signals and bitstrings according to the system's physical layer specifications. For example, during data transmission, the baseband processor 520 may encode and modulate a transmitted bitstring to generate complex symbols. In addition, during data reception, the baseband processor 520 may demodulate and decode a baseband signal provided from the RF processor 510 to restore a received bitstring. For example, when following the orthogonal frequency division multiplexing (OFDM) scheme, during data transmission, the baseband processor 520 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 520 may split a baseband signal provided from the RF processor 510 at the OFDM symbol level, may restore signals mapped to subcarriers through a fast Fourier transform (FFT) operation, and may restore a received bitstring through demodulation and decoding.

The baseband processor 520 and the RF processor 510 may transmit and receive signals as described above. Therefore, the baseband processor 520 and the RF processor 510 may be referred to as a transmitter, a receiver, a transceiver, or a communication unit. Furthermore, at least one of the baseband processor 520 and the RF processor 510 may include multiple communication modules to support multiple different radio access technologies. In addition, at least one of the baseband processor 520 and the RF processor 510 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mmWave) (e.g., 60 GHz) bands. The UE may transmit/receive a signal with the base station by using the baseband processor 520 and the RF processor 510, and the signal may include control information and data.

The memory 530 may store basic programs, application programs, and data, such as configuration information, for operation of the main base station. In particular, the memory 530 may store information related to the second access node, which performs wireless communication using the second wireless access technology. In addition, the memory 530 may provide the stored data at the request of the controller 540. In addition, the memory 530 may be configured by multiple memories. According to an embodiment, the memory 530 may store programs for performing the split bearer operating method of the disclosure.

The controller 540 may control the overall operation of the UE. For example, the controller 540 may transmit/receive signals through the baseband processor 520 and the RF processor 510. In addition, the controller 540 may record data in the memory 530 and reads the data from the memory 530. To this end, the controller 540 may include at least one processor. For example, the controller 540 may include a communication processor (CP) configured to perform control for communication, and an application processor (AP) configured to control upper layers such as application programs. In addition, at least one component in the UE may be implemented as a single chip. Furthermore, according to an embodiment of the disclosure, the controller 540 may include a multi-connection processor 542 which performs processing for operation in a multi-connection mode.

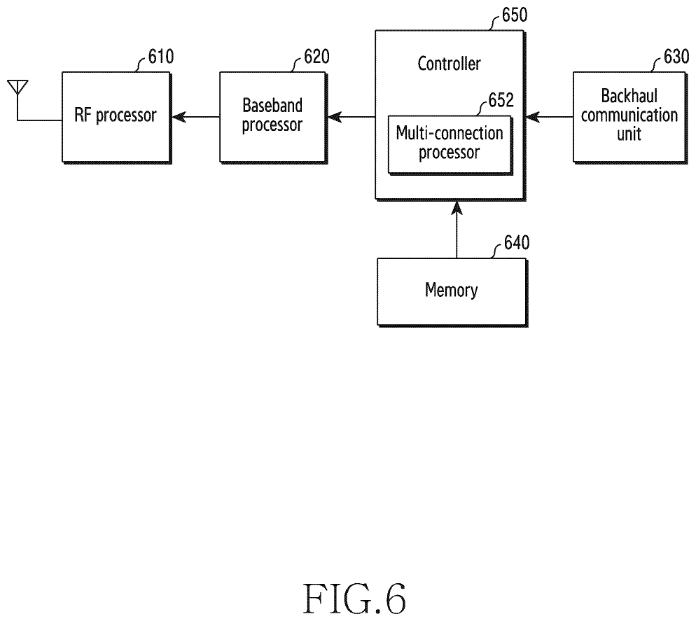

FIG. 6 is a block diagram illustrating a structure of a base station according to an embodiment of the disclosure.

Referring to FIG. 6, the base station may include an RF processor 610, a baseband processor 620, a backhaul communication unit 630, memory 640, and a controller 650. Obviously, the example given above is not limitative, and the base station may include a smaller or larger number of components than the components illustrated in FIG. 6.

The RF processor 610 may perform a function for transmitting and receiving a signal via a wireless channel, such as band conversion and amplification of the signal. That is, the RF processor 610 may up-convert a baseband signal provided from the baseband processor 620 to an RF band signal, may transmit the same through an antenna, and may down-convert an RF band signal received through the antenna to a baseband signal. For example, the RF processor 610 may include a transmission filter, a reception filter, an amplifier, a mixer, an oscillator, a DAC, and an ADC. Although only one antenna is illustrated in FIG. 6, the base station may include multiple antennas. In addition, the RF processor 610 may include multiple RF chains. Furthermore, the RF processor 610 may perform beamforming. For the beamforming, the RF processor 610 may adjust the phase and magnitude of each of signals transmitted and received through multiple antennas or antenna elements. The RF processor 610 may transmit one or more layers to perform a downward MIMO operation. The RF processor 610 may appropriately configure multiple antennas or antenna elements to perform reception beam sweeping or may adjust the direction and beam width of a reception beam so as to resonate the reception beam with a transmission beam under the control of the controller.

The baseband processor 620 may perform functions of conversion between baseband signals and bitstrings according to the physical layer specifications of first radio access technology. For example, during data transmission, the baseband processor 620 may encode and modulate a transmitted bitstring to generate complex symbols. In addition, during data reception, the baseband processor 620 may demodulate and decode a baseband signal provided from the RF processor 610 to restore a received bitstring. For example, when following the OFDM scheme, during data transmission, the baseband processor 620 may encode and modulate a transmitted bitstring to generate complex symbols, may map the complex symbols to subcarriers, and may configure OFDM symbols through the IFFT operation and CP insertion. In addition, during data reception, the baseband processor 620 may split a baseband signal provided from the RF processor 610 at the OFDM symbol level, may restore signals mapped to subcarriers through FFT operation, and may restore a received bitstring through demodulation and decoding. The baseband processor 620 and the RF processor 610 may transmit and receive signals as described above. Therefore, the baseband processor 620 and the RF processor 610 may be referred to as a transmitter, a receiver, a transceiver, a communication unit, or a wireless communication unit. The base station may transmit/receive a signal with the UE by using the baseband processor 620 and the RF processor 610, and the signal may include control information and data.

The backhaul communication unit 630 may provide an interface for performing communication with other nodes within a network. That is, the backhaul communication unit 630 may convert bitstrings transmitted from the main base station to other nodes, for example, auxiliary base stations, core networks, into physical signals, and may convert physical signals received from the other nodes into bitstrings.

The memory 640 may store basic programs, application programs, and data, such as configuration information, for operation of the main base station. In particular, the memory 640 may store information on bearers allocated to the connected UE, measurement results reported from the connected UE, and the like. In addition, the memory 640 may store information serving as a criterion for determining whether to provide or stop multiple connections to the UE. In addition, the memory 640 may provide data stored therein at the request of the controller 650. The memory 640 may store programs for performing the split bearer operating method of the disclosure.

The controller 650 may control the overall operation of the base station. For example, the controller 650 may transmit/receive signals through the baseband processor 620 and the RF processor 610 or through the backhaul communication unit 630. In addition, the controller 650 may record data in the memory 640 and reads the data from the memory 640. To this end, the controller 650 may include at least one processor. In addition, at least one component in the base station may be implemented as a single chip. In addition, at least one component in the base station may be implemented as a single chip. In addition, the respective components of the base station may be operated to perform the above-described embodiments of the disclosure. Furthermore, according to an embodiment of the disclosure, the controller 640 may include a multi-connection processor 652 which performs processing for operation in a multi-connection mode.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of a terminal connected to a first node and a second node in a dual connectivity environment, the method comprising:
performing a radio link failure (RLF) prediction of the second node;
transmitting, to at least one of the first node or the second node, a failure prediction report based on the RLF prediction; and
performing, by a packet data convergence protocol (PDCP) entity based on the RLF prediction, PDCP pre-recovery including at least one of:
stopping uplink PDCP packet data unit (PDU) splitting to a radio link control (RLC) entity related to the second node for a split bearer, or
retransmitting unacknowledged uplink PDCP data PDU previously submitted to an acknowledged mode (AM) RLC entity related to the second node for which successful delivery has not been confirmed by the AM RLC entity.

2. The method of claim 1, further comprising:
suspending the PDCP pre-recovery based on at least one of: an RLF detection, a PDCP pre-recovery operation period, a PDCP pre-recovery suspending indication, or a radio resource control (RRC) message from the at least one of the first node or the second node.

3. The method of claim 2, further comprising:
restoring, based on the suspending of the PDCP pre-recovery, configuration of at least one of cell group, data radio bearer (DRB), or RLC to a state configured prior to the PDCP pre-recovery.

4. The method of claim 1, further comprising:
transmitting, to the at least one of the first node or the second node, UE capability information related to at least one of the RLF prediction or the PDCP pre-recovery.

5. The method of claim 1, further comprising:
receiving, from the at least one of the first node or the second node, a radio resource control (RRC) message including configuration of at least one of the RLF prediction or the PDCP pre-recovery.

6. The method of claim 1, wherein the failure prediction report includes at least one of: a failure type, a predicted RLF occurrence time, or a measurement result related to the second node.

7. The method of claim 1, wherein the RLF prediction is performed in case that at least one of timers T310 or T312 is running, or in case that channel state of the at least one of the first node or the second node is poor.

8. A terminal connected to a first node and a second node in a dual connectivity environment, the terminal comprising:
at least one transceiver;
at least one processor communicatively coupled to the at least one transceiver; and
memory, communicatively coupled to the at least one processor, storing instructions executable by the at least one processor individually or in any combination to cause the terminal to:
perform a radio link failure (RLF) prediction of the second node,
transmit, to at least one of the first node or the second node, a failure prediction report based on the RLF prediction, and
perform, by a packet data convergence protocol (PDCP) entity based on the RLF prediction, PDCP pre-recovery including at least one of:
stopping uplink PDCP packet data unit (PDU) splitting to a radio link control (RLC) entity related to the second node for a split bearer, or
retransmitting unacknowledged uplink PDCP data PDU previously submitted to an acknowledged mode (AM) RLC entity related to the second node for which successful delivery has not been confirmed by the AM RLC entity.

9. The terminal of claim 8, wherein the memory stores instructions executable by the at least one processor individually or in any combination to further cause the terminal to:
suspend the PDCP pre-recovery based on at least one of: an RLF detection, a PDCP pre-recovery operation period, a PDCP pre-recovery suspending indication, or a radio resource control (RRC) message from the at least one of the first node or the second node.

10. The terminal of claim 9, wherein the memory stores instructions executable by the at least one processor individually or in any combination to further cause the terminal to:
restore, based on the suspension of the PDCP pre-recovery, configuration of at least one of cell group, data radio bearer (DRB), or RLC to a state configured prior to the PDCP pre-recovery.

11. The terminal of claim 8, wherein the memory stores instructions executable by the at least one processor individually or in any combination to further cause the terminal to:
transmit, to the at least one of the first node or the second node, UE capability information related to at least one of the RLF prediction or the PDCP pre-recovery.

12. The terminal of claim 8, wherein the memory stores instructions executable by the at least one processor individually or in any combination to further cause the terminal to:
receive, from the at least one of the first node or the second node, a radio resource control (RRC) message including configuration of at least one of the RLF prediction or the PDCP pre-recovery.

13. The terminal of claim 8, wherein the failure prediction report includes at least one of: a failure type, a predicted RLF occurrence time, or a measurement result related to the second node.

14. The terminal of claim 8, wherein the RLF prediction is performed in case that at least one of timers T310 or T312 is running, or in case that channel state of the at least one of the first node or the second node is poor.
